(19) United States
(12) Patent Application Publication
(10) Pub. No.: US 2008/0056338 A1
(43) Pub. Date: Mar. 6, 2008

(54) Power Line Communication Device and Method with Frequency Shifted Modem

(76) Inventors: David Stanley Yaney, Poolesville, MD (US); Robert James Mckay, Woodbine, MD (US)

Correspondence Address: CAPITAL LEGAL GROUP, LLC, 1100 River Bay Road, Annapolis, MD, 21409, US

(21) Appl. No.: 11/467,707

(22) Filed: Aug. 28, 2006

(51) Int. Cl. H04L 5/16

(52) U.S. Cl. 375/222

(57) ABSTRACT

A power line communication device for communicating data over a power line in a frequency shifted communication band is provided. One embodiment includes a controller having a memory, a modem in communication with the controller, a clock generation circuit to provide a first clock output controlled by the controller. The embodiment also includes a first mixer configured to receive the first clock output from the clock generation circuit and a data signal input from the modem and to provide a shifted data signal output. The embodiment may also include a second mixer configured to receive a second clock output from the clock generation circuit and an external data signal input and to provide a shifted data signal input to the modem for demodulation. The controller is configured to receive information from the modem and to cause the clock generation circuit to adjust the first and second clock outputs accordingly. The clock generation circuit also may include a voltage controlled oscillator controlled by the controller via a digital to analog converter.

### FIELD OF THE INVENTION

The present invention generally relates to devices and methods for communicating over a power line, and more particularly to devices and methods for shifting communication frequencies.

### BACKGROUND OF THE INVENTION

A power line communication system (PLCS) may use the infrastructure of existing power distributions systems to form a communication network. A power line communication device having a modem may be used to transmit and receive communications along the power lines at various points in the power line communication system, such as, for example, near homes, offices, IP network service providers, and the like. By connecting a power line communication system to a global information network, such as the internet, many communication and information services become available to PLCS subscribers. A subscriber of a power line communication system (PLCS) may couple a user device to in-home low voltage power lines to transmit and receive power line communications. High data rate services may be delivered to the end users along medium voltage power lines and/or low voltage power lines, which may include in-building low voltage power lines.

The modem of a power line communication device typically has what is referred to as a native communication frequency band. In many instances, however, it is desirable to communicate at a frequency band different than the native frequency band. However, changing the frequency of the incoming and outgoing data signals can be problematic. For example, conventional modem chips are designed to work with a crystal that forms part of an oscillator used to establish the basic timing of the modem chip (meant to include chip sets and integrated circuits herein). Typically, a manufacturer designs a modem chip to be used with inexpensive crystals. Such crystals may have a relatively large natural frequency variance from crystal to crystal. A modem design based on such a crystal typically is designed to tolerate the natural frequency variations that may occur from crystal to crystal.

Frequency shifting circuits often further include a local oscillator circuit. However, variations in the frequencies of local oscillators associated with the sending and receiving modems may cause the shifted data signals to be unintelligible by the receiving modem—especially when the crystal used to establish the basic timing of one or both modems is at, or near, the maximum tolerable variation. In particular, communication transmission and communication reception can become unreliable or impossible.

For example, coherent orthogonal frequency division multiplexing (OFDM) modems are particularly susceptible to local oscillator errors when frequency shifting is implemented. One prior art solution is to tune the crystals, which may include testing and using only crystals within a very small predetermined tolerance. However, this solution is very expensive and may not address the problem of crystal drift in which the frequency of oscillation of the crystal changes (drifts), such as over time or due to other factors such as temperature variation. Accordingly, there is a need for lower cost, effective methods for minimizing the local oscillator offsets among frequency-shifted modems.

### SUMMARY OF THE INVENTION

The present invention provides a power line communication device for communicating data over a power line in a frequency shifted communication band. One embodiment includes a controller having a memory, a modem in communication with the controller, a clock generation circuit to provide a first clock output controlled by the controller. The embodiment also includes a first mixer configured to receive the first clock output from the clock generation circuit and a data signal input from the modem and to provide a shifted data signal output. The embodiment may also include a second mixer configured to receive a second clock output from the clock generation circuit and an external data signal input and to provide a shifted data signal input to the modem for demodulation. The controller is configured to receive information from the modem and to cause the clock generation circuit to adjust the first and second clock outputs accordingly. The clock generation circuit also may include a voltage controlled oscillator controlled by the controller via a digital to analog converter

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of a pair of conventional communication modules; and

FIG. 2 is a block diagram of a communication module according to one example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

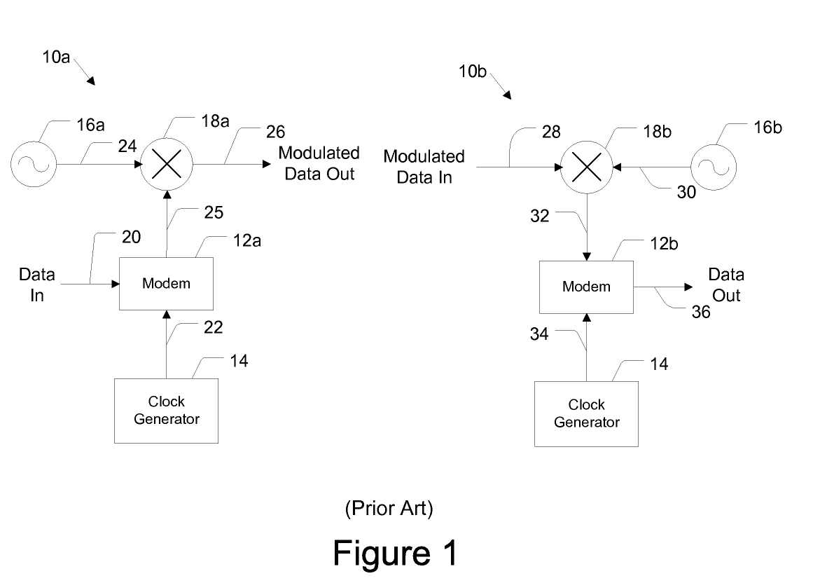

FIG. 1 shows two communication modules 10a,b. Communication module 10a is configured for transmission, while the communication module 10b is configured for reception. Each communication module 10 includes a modem chip (or chip set) 12, a clock generator 14, a local oscillator 16, and a mixer 18.

Communication devices having communication modules 10 may communicate over a given communication medium, such as a wireless medium, a fiber optic medium (with an appropriate media converter), a twisted pair medium, a coaxial cable, or a power line cable or conductor. For a transmit operation from one communication device, the modem 12a of the communication module 10a receives data 20 from a user device (not shown) such as, for example, a computer. The data 20 is modulated (among other things) by modem 12a, which receives timing information 22 from the clock generator 14. The modulated data signal 25 then is mixed at the mixer 18a with a local oscillator (LO) signal 24 generated by the local oscillator 16a. The mixer 18a performs a heterodyning function to produce the sum and difference of the LO signal 24 and the baseband input signal (the modulated data signal 25), one of which will be within a desired frequency band to which data signals are to be shifted. The result is an output signal 26 which is transmitted by the communication module 10a over the given communication medium in a frequency band different from the native frequency of the modem 12a.

For a receive operation at a communication device, the module 10b receives an input signal 28 (e.g., from a device having a module 10a) over a given communication medium. The mixer 18b receives the incoming signal 28, and receives a LO signal 30 from the local oscillator 16b. The mixer 18b mixes the incoming signal 28 with the LO signal 30 to provide a signal 32 which is (or should be) within the native frequency band of the modem 12b. For example, the mixer 18b may provide the difference between the incoming data signal 28 and the LO signal 30, so as to shift frequencies down to the native frequency band. The modem 12b demodulates the signal 32 using a timing signal 34 received from the clock generator 14.

The example embodiment of the present invention described below employs orthogonal frequency division multiplexing (OFDM) modulation although other types of modulation could be used as well. OFDM is a technique for transmitting large amounts of digital data using multiple carriers over a frequency band. Specifically, in OFDM communications a single transmitter transmits on many different orthogonal frequencies (typically dozens to thousands). Typically, the frequencies are closely spaced so that each carries a narrowband signal. An OFDM carrier signal is the sum of the orthogonal sub-carriers, with baseband data on each sub-carrier being independently modulated commonly using some type of quadrature amplitude modulation (QAM) or phase-shift keying (PSK).

It is common for modem-based communication devices to experience errors in receiving communications. To properly recover the transmitted signal, a communication device implementing OFDM may need to precisely sample the incoming signal 28 and establish synchronization to it. Fundamental timing issues in a frequency shifted system are: (i) accurately establishing the digital sampling clock (from clock generator 14); and (ii) removing local oscillator 16 offset caused by frequency inaccuracies during the frequency shifting process. The tolerable errors for both digital sampling clock and local oscillator depend on the details of the OFDM signal set, e.g., differential vs. coherent modulation, modulation depth, symbol and frame duration, etc. Errors in the digital sampling (i.e., due to clock generator 14) typically may result in errors referred to as frequency “stretch” errors (e.g., because of the way the distortion of the output spectrum would appear if viewed with sufficient precision on a spectrum analyzer) and frequency “shift” errors (e.g., because the entire resulting spectrum is simply shifted by a fixed amount in frequency). Errors in the local oscillator(s) also may cause frequency “shift” errors.

OFDM data signals are subject to several distortions during the process of data reconstruction by the receiver. First, the data signal may exhibit a stretch error and shift error due to imprecision of the clock generator 14 design. For example, basic sampling errors appear when the digital clock generator 14b at a receiving device 10b differs from that at the transmitting device 10a. This difference gives rise to the same fixed percentage error in reconstructing all frequencies in the received spectrum. Hence the higher frequencies appear to shift more than the lower ones and the resulting recovered spectrum appears to both stretch in frequency space according to the net offset between the transmit and receive clock generators 14

When local oscillator error is present, the OFDM data signals are generated in one band and undergo a frequency shift before transmission. If the local oscillator 16b of the receiving device 10b performing frequency conversion (e.g., shifting the frequency down such as in the example of FIG. 1) has a different natural frequency from that used at the transmitting device 10a, then the recovered data signals may be linearly shifted in frequency space according to the net error between the two local oscillators. In such case, all frequencies undergo substantially the same frequency shift.

Of significance is that when the respective local oscillators 16 of a transmitting device and receiving device are not substantially identical, error rates increase due to the oscillator differences. The different natural frequencies of the local oscillators 16a, 16b may compound (i.e., be added to) differences in the clock generators 14 of the communication devices 10.

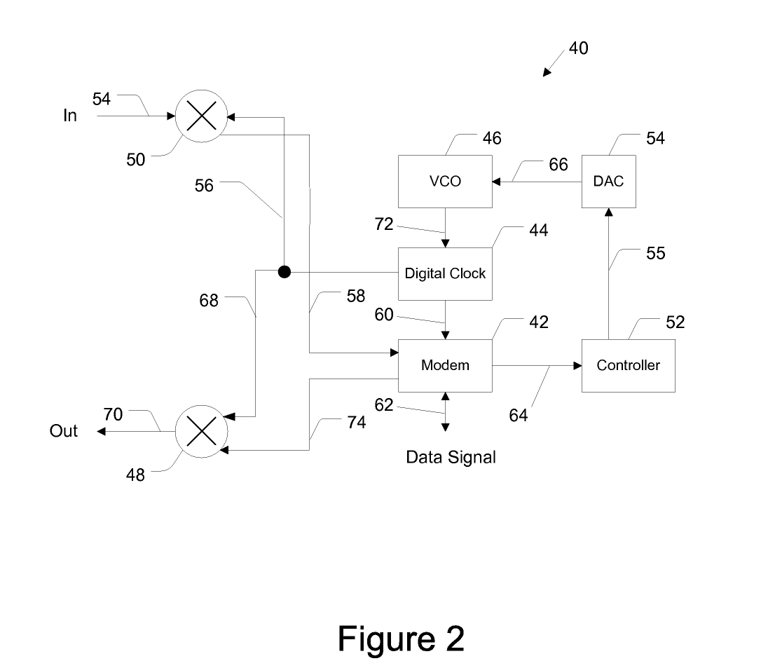

FIG. 2 shows a communication module 40 according to an example embodiment of this invention. The communication module 40 may form part of a communication device configured to communicate over a power line (e.g., an overhead medium voltage power line, an underground residential distribution (URD) medium voltage power line, an internal or external low voltage power line), a coaxial cable, a twisted pair, or another communication medium. For example, the communication module 40 may be included in a HomePlug® power line modem or a device that includes a HomePlug power line modem chip set such as a backhaul point, transformer bypass device, low voltage repeater, or medium voltage repeater. It is noted that the modem 42 shown in the figures is meant to depict modem chips, chips, and/or integrated circuits of a communication device. In this example embodiment, the module 40 may include a modem 42, a digital clock 44, a voltage controlled oscillator 46, mixers 48, 50, a controller 52 and a digital to analog converter 54. The mixers 48, 50 are coupled to a communication medium, such as a power line, a coaxial cable, a fiber optic cable, a twisted pair or a wireless medium (e.g., through conventional amplifiers and filters). In this embodiment, the modem 42 is full duplex while in other embodiments the modem 42 may be half-duplex in which case only one mixer 50 may be needed or desired.

In this example embodiment, the communication module 40 (and modem 42) may execute a coherent communication scheme. A coherent modem establishes the reference point of the constellation at the beginning of a series of symbols and then extracts the data by comparing the “I” (in-phase) and “Q” (quadrature or out-of-phase) signals from the current symbol against the reference. A modem which is differentially coded carries the data in the differences between the I and Q signals of one symbol and the next. Thus, in a differential modem the elapsed time of importance is the symbol period while in a coherent modem it is the frame period. Because there are typically hundreds of symbols per frame one can immediately see why differential modems are more tolerant of clock errors (both digital and LO) than coherent modems.

In this example embodiment, one communication device may be assigned to be a master device. This means that the clock for such master device is to be the reference clock with which the communication modules 40 of the other communication devices on that network are to be synchronized. In other words, when a master device is assigned, transmitted communications are sent (and received communications are received) with the voltage controlled oscillator 46 set using the error data stored in controller 52 for communicating with the master device. In order to synchronize the devices with the master device, the devices may employ a tuning process.

Specifically, to reduce potential digital clock and local oscillator errors, the communication module 40 may periodically or aperiodically perform a tuning process, in which several reference symbols are transmitted to another communication device (not shown) to which it may be communicatively linked. The process may be performed for several remote communication devices, such as any one or more of the communication devices with which the device 40 can communicate. For a given communication link between the communication module 40 and another communication device, the reference symbols are used to algorithmically extract the digital clock error, which may be stored in memory. In this example embodiment, a plurality of devices may perform the tuning process to synchronize with a master device and store the error information in their local memory.

To minimize or avoid stretch errors and local oscillator errors, the module 40 tunes itself using the error data previously stored. In particular, the module 40 tunes itself for communicating with a given communication device using the error information previously obtained for the master device. One object of the tuning process is to adjust digital clock error to zero (or approximately zero) for current communications. Because all of the devices on a network may synchronize with the same master device, this means that the clock of the transmitting device and the receiving device are to be substantially the same.

In this example embodiment, the tuning communications may be the first communications between the devices (e.g., at power up, reset, or if communications break down). The tuning communications between the devices typically may initially include using a more robust modulation technique, which may be, for example, a differential modulation scheme (e.g., differential phase shift keying or DPSK), or a coherent modulation scheme that has a low data rate (and, therefore, has can tolerate more noise and crystal variance). After initial communications (e.g., to determine which device is the master), to perform the tuning (i.e., to synchronize the clocks) the devices may transmit and receive fully coherent frames, which may comprise data frames that are worst case data frames (e.g., largest in size and/or most complex the modulation scheme) for the network or modem 42. Then, after the devices become synchronized, the data rate may be increased with the use of a more complex and higher data rate modulation scheme, which may be a coherent modulation scheme. Thus, early communications between devices just “coming up” on the network may contain a mix of differential coding and coherent coding the same data frames.

In this embodiment of the tuning process, the reference symbols are transmitted from a local communication device (e.g., the master device) to a remote communication device (e.g., as part of a channel estimation process). The remote communication device recognizes the data (e.g., as user data or as non-user data) and processes the data accordingly (which may include using the data for tuning). For example, the received reference symbols at the local communication device are used to tune communications with the master device. Referencing FIG. 2, the received reference symbols are received in a communication signal 54 received at the mixer 50. The mixer 50 also receives a local oscillator (LO) signal 56 from the digital clock 44 (which may be provided to the LO 40 via a fractional phase locked loop (PLL) circuit not shown). The mixer 50 mixes the incoming signal 54 with the LO signal 56 to provide a signal 58 which is (or should be) within the native frequency band of the modem 42. For example, the mixer 50 may provide the difference between the incoming signal 54 and the LO signal 56 to thereby shift the frequency down. The modem 42 demodulates the shifted signal 58 using a clock signal 60 received from the digital clock 44. The resulting data signal 62 includes the reference symbols. The digital clock 44 receives a LO signal 72 from VCO 46, which has been adjusted by controller 52 via DAC 54. Thus, this example embodiment provides two adjustments. First, the frequency of the LO 50 is adjusted by the digital clock 44 (via a fractional PLL) and, second, the clock signal 60 of the modem 42 is also adjusted by digital clock 44.

Of significance here is the LO signal 56 generated by the voltage digital clock 44. The modem 42 determines the receive clock error data 64 which is output to the controller 52. The controller 52 stores the received clock error data so as to correspond to the master device. The error data also is used to output a digital tuning signal 55 to the digital to analog converter (DAC) 54 to adjust the output voltage of the DAC. Such adjustment alters the output voltage 66 received by the voltage controlled oscillator 46. In response, the voltage controlled oscillator 46 adjusts its output frequency 72 (up or down according to the adjusted voltage) supplied to the digital clock 44. These devices thus form a correction loop. As the returning reference symbol communication continues, the modem 42 generates additional receive clock error data 64 which are received (and stored) by the controller 52. In response the controller 52 adjusts the output to the DAC 54, which in turn alters the voltage of signal 66 received at the voltage controlled oscillator 46. In response the voltage controlled oscillator 46 adjusts its output frequency. Gradually, the receive clock error signal 64 generated by the modem 42 is reduced and in some cases may approximate or equal zero, (i.e., no error). In some embodiments, the correction loop may contain a digital filter to improve stability. The digital filter may be implemented in software stored in (and executed by) the controller 52.

In this example embodiment, the modules 40 each form part of a power line communication device (e.g., repeater, transformer bypass device) configured to communicate over a medium voltage power line. One of the power line communications devices comprises a backhaul device that interfaces the power line to a conventional telecommunications medium (e.g., fiber or wireless) and which may be designated (e.g., based on the media access control (MAC) address of the backhaul device) as the master device. Power line, as used herein, is meant to include any of a power line cable, a power line conductor, or group of power line conductors (e.g., two low voltage power line conductors and neutral conductor), which may be used to facilitate high voltage, medium voltage, or low voltage power delivery. Thus, in this embodiment, as a result of the tuning the controller 52 of each device stores the error data used to reduce or eliminate the receive clock error signal 64 for communications with the backhaul device. Furthermore, because all of the devices are tuned to the master device, they are also tuned to each other.

After the tuning is complete, the module 40 adjusts itself for such communications. In particular, for reception, the stored error data in the controller 52 is used to set the voltage controlled oscillator 46 frequency to reduce or eliminate stretch (and thereby also the LO error) for the received communication. Accordingly, a communication signal 54 is received at the mixer 50. The mixer 50 also receives a LO signal 56 from the digital clock 44 as set by the VCO 46 receiving a voltage 66 from the digital to analog converter (DAC) 54 under control of controller 52. In particular, the controller 52 initially outputs a tuning signal 55 to the DAC 54 based upon the stored error data corresponding to the master device. The output 72 of the VCO 46 sets digital clock 44 frequency, which supplies a timing signal 60 to modem 42, and also provides the LO signal 72 to mixer 50. It is worth noting that, the transmitting device will be synchronizing its transmission according to the clock of the master device as well. Consequently, in this example embodiment, even though the communication is not from the master device itself, the error typically will still be small and may approach zero.

The mixer 50 mixes the incoming signal 54 to provide a data signal 58 (which has been frequency shifted) to the modem 42. The modem 42 demodulates the signal 58 using a clock signal 60 received from the digital clock 44 (which frequency is adjusted via the VCO 46). The resulting signal 62 may be output to the controller 52 or another device coupled to the modem 42. For example, a computer or other digital device having a processor may be coupled to the module 40 (e.g., at the modem 42) and use the module 40 for communications. As the communication continues, the modem 42 may generate a receive clock error signal 64, just as it did during the tuning operation. The receive clock signal 64 is output to the controller 52 and stored. In response the controller may adjust the output to the DAC 54 (if necessary), which in turn alters the voltage signal 66 received at the voltage controlled oscillator 46. In response, the voltage controlled oscillator 46 adjusts its output frequency fed to the digital clock 44 from which the LO signals 56 and 68 are derived. Accordingly, further tuning may occur for later communications after the initial tuning process. Because a separate tuning process has been performed previously, the current communications with a given communication device may have fewer errors and may more quickly achieve a reduced or ‘zero’ receive clock error signal 64. In addition, such further and/or periodic tuning is beneficial for compensating for drift errors which may occur.

In general for a transmit operation by communication module 40, the modem 42 receives a data 62 from the controller 52 or from an external user device (not shown). The voltage controlled oscillator 46 is controlled by a voltage signal 66 from the DAC 54, which in turn is controlled by the tuning signal 55 from the controller 52. The frequency of clock 44 is set by a signal 72 from the voltage controlled oscillator 46. The LO 48 is set via a LO signal 68 derived from the digital clock 44. In this embodiment, the LO signal 68 is supplied to the LO 48 via a fractional PLL (not shown). Based on the retrieved error data, the controller 52 adjusts the voltage controlled oscillator 46 (through the output voltage of the DAC 54) so as to be in synchronization with (e.g., adjusted to) the clock of a master device. The data 62 is modulated by the modem 12 using a clock signal 60 received from the digital clock 44. The modulated data signal 74 then is mixed (e.g., added) at the mixer 48 with an LO signal 68 derived from the digital clock. The result is a modulated data signal 70 which is transmitted by the communication module 40 over the given communication medium at a frequency that is different (e.g., higher) than the native frequency of modem 42. It is worth noting that the corrections applied by the circuit 40, in this embodiment, are derived from transmissions made by other parts of the protocol (e.g., non-user data communications) or as a result of the link passing user data. One advantage of such as system is that the correction procedure is largely transparent to the user with little to no impact on the system performance)

The communication device which is designated as the master device may change. In addition, a communication device may transmit a command naming itself as the master device so that all the other devices adjust their oscillators to be in synch with the new master device. If the device is configured to be synchronized for communications over more than one network (which each may have a different master device), the controller may select and retrieve one from a plurality of error data stored in memory. For example, the controller may determine the destination address for the communication to be transmitted and retrieve the error data for the master device of the network of the destination device. While not shown in the figures, the module 40 may include a transit receive switch for switching between transmit and receive operations (e.g., in half duplex embodiments using only one LO). In addition, the module 40 may include amplifiers, bandpass filters, transient protection circuitry and other conditioning circuitry between the mixers and the power line or other medium. In addition, the module may be used in a power line communication device to communicate over any of high, medium, or low voltage power lines. Such device may also include a router coupled to the modem for routing data or the controller 52 may perform routing functions. Examples of power lines communication devices such as transformer bypass devices, backhaul devices, and repeaters are provided in U.S. application Ser. No. 11/091,677, filed Mar. 28, 2005, entitled “Power Line Repeater System and Method”, which is hereby incorporated by reference in its entirety.

In some embodiments, the clock generation circuit may include more than one oscillator. For example, a first VCO may control the LO signal supplied to the first mixer, a second VCO may control the LO signal supplied to the second mixer; and a third VCO may control the LO signal supplied to the modem.

In another embodiment, the modules 40 of the respective communication devices may synchronize to a tone or other synchronization signal transmitted by a master device. Each module 40 may communicate (transmit and/or receive) data using a frequency band different from the other modules 40. In other words, the modules 40 may communicate via a frequency division multiplexed (FDM) communications scheme. In such an embodiment, the fractional phase locked loop (from which the LO signal is derived from the digital clock 44) may be controlled via the controller 52 so that the local oscillator of each module 40 shifts the native frequency band of its modem 42 to a different frequency band (as designated by a command from the master device) thereby allowing for a dynamic and reconfigurable FDM system. Such as system may communicate over power lines, a coaxial cable, or another medium. The synchronization signal may be a set of symbols repeated over and over or a simple tone.

Using a coaxial cable, a plurality of master devices and their associated slave devices may all communicate over the same coaxial cable using different frequency bands. All the devices may be synchronized using a channel lock signal (e.g., a signal tone) and the slave devices may be logically assigned to a particular master device dynamically. The data side of the master devices may be “bonded” together (e.g., they may be co-located), with additional master devices added as bandwidth and other considerations deemed it necessary. The slave devices of such an embodiment may be configured to communicate with a master device via a coaxial cable and with a plurality of user devices via a low voltage power line(s) (or wirelessly using IEEE 802.11). Examples of communication devices that communicate via a coaxial cable that extends from transformer to transformer and that also communicate with one or more user devices (e.g., via low voltage power lines or wirelessly) are provided in U.S. application Ser. No. 11/467,591, filed Aug. 28, 2006, entitled “Power Line Communication System and Method”, which is hereby incorporated by reference in its entirety.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A power line communication device for communicating data over a power line, comprising:
a controller having a memory;
a modem in communication with the controller;
a clock generation circuit configured to provide a first clock output and wherein said controller is operatively coupled to said clock generation circuit;
a first mixer configured to receive the first clock output from said clock generation circuit and a data signal input from said modem and to provide a shifted data signal output to be communicated over the power; and
wherein said controller is configured to receive information from said modem and to cause said clock generation circuit to adjust the first clock output.

2. The device of claim 1, wherein said clock generation circuit includes a voltage controlled oscillator.

3. The device of claim 1, wherein said clock generation circuit includes a voltage controlled oscillator and said controller is operatively coupled to said clock generation circuit via a digital to analog converter.

4. The device of claim 1, wherein said modem is configured to communicate via a coherent modulation method.

5. The device of claim 1, wherein said clock generation circuit is configured to provide a second clock output to said modem; and
wherein said controller is configured to cause said clock generation circuit to adjust the second clock output

6. The device of claim 5, wherein the second clock output is provided to said modem via a digital clock circuit.

7. The device of claim 5, wherein said first clock output is derived from said second clock output.

8. The device of claim 1, wherein said controller is configured to store the received information in said memory.

9. The device of claim 1, further comprising a second mixer configured to receive a second clock output from said clock generation circuit and an external data signal input and to provide a shifted data signal input to said modem; and
wherein said controller is configured to cause said clock generation circuit to adjust the second clock output.

10. A method of providing data communications over a power line, comprising:
receiving a first data signal input from the power line;
(a) mixing the data signal input with a first clock signal to provide a shifted data signal input;
(b) demodulating the shifted data signal input to provide first data;
(c) determining error data;
(d) adjusting the first clock signal based on the error data;
providing a second clock signal to the modem; and
adjusting the second signal based on the error data.

11. The method of claim 10, further comprising prior to said mixing:
retrieving information from memory; and
adjusting the first clock signal according to said retrieved information.

12. The method of claim 10, wherein said adjusting comprises adjusting the voltage supplied to a voltage controlled oscillator.

13. The method of claim 10, wherein said demodulating is accomplished via a coherent modulation method.

14. The method of claim 10, wherein the first clock signal is based on the second clock signal.

15. The method of claim 10, wherein the first clock signal is derived from the second clock signal via a fractional phase locked loop.

16. The method of claim 10, further comprising storing the error data in a memory.

17. The method of claim 10, further comprising
receiving a second data;
providing a modulated second data signal representing the second data;
mixing the modulated second data signal with a third clock signal to provide a shifted data signal output; and
transmitting the shifted data signal output over the power line.

18. The method of claim 17, further comprising
retrieving information from memory; and
adjusting the third clock signal according to said retrieved information prior to said mixing of the second data signal.

19. The method of claim 10, further comprising repeating steps (a), (b), (c), and (d) for one or more received data signals to reduce the error rate of received data signals.

20. A power line communication device for communicating data over a power line, comprising:
a controller having a memory;
a modem in communication with the controller;
a clock generation circuit configured to provide a first clock output and a second clock output and wherein said controller is operatively coupled to said clock generation circuit;
a first mixer configured to receive the first clock output from said clock generation circuit and a data signal input from said modem and to provide a shifted data signal output;
wherein said modem is configured to receive the second clock output; and
wherein said controller is configured to receive information from said modem and to cause said clock generation circuit to adjust the first clock output and the second clock output based, at least in part, on said information.

21. The device of claim 20, wherein the power line comprises a medium voltage power line carrying a voltage greater than one thousand volts.

22. The device of claim 20, wherein said clock generation circuit includes a voltage controlled oscillator and said controller is operatively coupled to said clock generation circuit via a digital to analog converter.

23. The device of claim 20, wherein said modem is configured to communicate via a coherent modulation method.

24. The device of claim 20, wherein said controller is configured to store the received information in said memory.

25. The device of claim 20, further comprising a second mixer configured to receive a third clock output from said clock generation circuit and an external data signal input and to provide a shifted data signal input to said modem; and
wherein said controller is configured to adjust the third clock output.

26. The device of claim 20, wherein said first mixer is configured to receive an external data signal input and to provide a shifted data signal input to said modem.

27. The device of claim 20, further wherein the first clock output is derived from the second clock output.

28. A method of providing data communications, comprising:
coupling a plurality of devices to each other via a coaxial cable;
transmitting a synchronization signal over the coaxial cable to the plurality of devices;
at each of the plurality of devices:
receiving the synchronization signal;
receiving a data signal input from the coaxial cable;
mixing the data signal input with a first clock signal to provide a shifted data signal input;
demodulating the shifted data signal input to provide first data;
determining error data;
adjusting the first clock signal based on the error data;
providing a second clock signal to a modem; and
adjusting the second clock signal based on the error data.

29. The method of claim 28, further comprising prior to said mixing:
retrieving information from memory; and
adjusting the first local oscillator signal according to said retrieved information.

30. The method of claim 28, wherein said adjusting comprises adjusting the voltage supplied to a voltage controlled oscillator.

31. The method of claim 28, wherein said demodulating is accomplished via a coherent modulation method.

32. The method of claim 28, wherein the first clock signal is based on the second signal.

33. The method of claim 32, wherein adjusting the first clock signal also adjusts the second clock signal.

34. The method of claim 28, wherein the first clock signal is derived from the second signal via a fractional phase locked loop.

35. The method of claim 28, further comprising storing the error data in a memory.

36. The method of claim 28, further comprising
receiving a second data;
providing a modulated second data signal representing the second data;
mixing the modulated second data signal with a second clock signal to provide a shifted data signal output; and
transmitting the shifted data signal output.

37. The method of claim 28, wherein the error data is derived from the synchronization signal.

38. The method of claim 28, wherein the plurality of devices are synchronized to synchronization signal.

39. The method of claim 28, further comprising transmitting the first data over a power line.
